(19) United States
(12) Patent Application Publication
(10) Pub. No.: US 2007/0190387 A1
(43) Pub. Date: Aug. 16, 2007

(54) Electronic components

(76) Inventors: Ryuji Kohno, Kasumigaura (JP); Yasuaki Norimatsu, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/527,409

(22) Filed: Sep. 27, 2006

(30) Foreign Application Priority Data
Feb. 16, 2006 (JP) 2006-039202

(51) Int. Cl. H01M 8/02

(52) U.S. Cl. 429/34

(57) ABSTRACT

A cellular mobile telephone is provided with a fuel cell of high power output. The cellular mobile telephone includes a plate-formed fuel cell section having at least two cells for generating power by an aqueous solution containing methanol being supplied to an anode and the air containing oxygen to the cathode, wherein these two or more cells are arranged on both sides thereof; an cellular mobile telephone body utilizing the power of the fuel cell section; and a hinge mechanism for linking the fuel cell section 10 and cellular mobile telephone body rotatably with respect to each other.

### CLAIM OF PRIORITY

The present application claims priority from Japanese application serial no. 2006-39202, filed on Feb. 16, 2006, the content of which is hereby incorporated by reference into this application.

### BACKGROUND OF THE INVENTION

1. Field of Technology

The present invention relates to electronic components incorporating a cell for generating power in response to the supply of a liquid fuel and oxidizing gas.

2. Background of Art

In recent years, fuel cells including a Direct Methanol Fuel Cell (DMFC) and Polymer Electrolyte Fuel Cell (PEFC) are developed actively. The fuel sells are expected to provide effective power supplies for compact electronic components such as cellular mobile telephones.

Of the aforementioned fuel cells, the DMFC, for example, incorporates a (single) cell which generates power in response to the supply of a liquid fuel and oxidizing gas. This cell includes an MEA (Membrane Electrode Assembly) made up of an electrolyte membrane sandwiched between an anode (fuel pole) and a cathode (air pole), and a conductive member (e.g., a current collector and metallic separator) sandwiching the MEA (see the Patent Document 1).

However, the electromotive force of this cell is the order of 0.7 through 0.9 volts. This requires adequate serial connection of a plurality of cells in conformity to the requirements of an external load. Thus, to ensure a high volume efficiency with serial connection of two cells, a structure has been proposed, wherein a fuel tank is sandwiched between these two cells so that the tank is shared by these cells. In the present Specification, such a structure will be referred to as a cell/tank structure. Incidentally, this fuel tank is a secondary tank wherein an aqueous solution containing methanol (liquid fuel) supplied from the primary tank of an external fuel cartridge or the like is led to the anodes of the cells on both sides. The cathodes located on both external sides of this cell/tank structure must be exposed to the outside to ensure that air including oxygen as an oxidizing gas will be supplied.

[Patent Document 1] Japanese Patent Laid-open No. Hei 9(1997)-92323

### SUMMARY OF THE INVENTION

(Problems to be Solved by the Invention)

A collapsible cellular mobile telephone incorporates a dial button, liquid crystal panel and others in the inner surface, with a rear display arranged on the outer surface (back surface). Accordingly, the cellular mobile telephone of such a conventional structure cannot be provided with a cell/tank structure containing cathodes on both external surfaces.

The object of the present invention is to provide electronic components equipped with a fuel cell characterized by a high volume efficiency and high power output.

### (Means for Solving the Problems)

The aforementioned problem can be solved by electronic components including a plate-formed fuel cell section further comprising at least two cells for generating power by a liquid fuel being supplied to the anode and an oxidizing gas being supplied to the cathode, wherein the at least two cells are arranged on both sides thereof; an electronic component body utilizing the power of the fuel cell section; and a rotating mechanism for linking the fuel cell section and the electronic component body rotatably with respect to each other.

According to the aforementioned electronic components, when the at least two cells are made to generate power, the fuel cell section and electronic component body are rotated relatively by the rotating mechanism, whereby oxidizing gas is supplied to each of the cathodes of the two or more cells. That is, the fuel cell section can incorporate a cell/tank structure having cathodes on both external surfaces, whereby the volume efficiency is increased. In result, the two or more cells can generate power, and the fuel cell section produces a high power output.

As described above, dial buttons, liquid crystal panel and others can be mounted on the surface of the electronic components, because the fuel cell section and electronic component body are rotated by the rotating mechanism.

(Effects of the Invention)

According to the present invention, it is possible to provide electronic components equipped with a fuel cell characterized by a high volume efficiency and of high power output.

### BRIEF DESCRIPTION OF THE DRAWINGS

FIG. 1A is a perspective view representing the cellular mobile telephone of the present embodiment, wherein shows the fuel cell section in the collapsed state.

FIG. 1B is a perspective view representing the fuel cell section in the process of being opened.

FIG. 1C is a perspective view indicating the fuel cell section in the open state.

FIG. 2 is a enlarged perspective view representing the fuel cell section of FIG. 1.

FIG. 3 is a perspective view representing the DMFC body of the present embodiment.

FIG. 4 is an exploded perspective view representing the DMFC body of the present embodiment.

FIG. 5 is a cross section view taken along an arrow line X1-X1 representing the fuel cell section shown in FIG. 2.

FIG. 6 is a cross section view taken along an arrow line X2-X2 representing the fuel cell section shown in FIG. 2.

FIG. 7A is a perspective view representing the cellular mobile telephone as another embodiment, wherein shows the fuel cell section in the collapsed state.

FIG. 7B is a perspective view representing the fuel cell section in the process of being opened.

FIG. 7C is a perspective view indicating the fuel cell section in the open state.

FIG. 8A is a perspective view representing the cellular mobile telephone as another embodiment, wherein shows the fuel cell section in the collapsed state.

FIG. 8B is a perspective view representing the fuel cell section in the process of being opened.

FIG. 8C is a perspective view indicating the fuel cell section in the open state.

FIG. 9A is a perspective view representing the digital camera as another embodiment, wherein shows the fuel cell section in the collapsed state.

FIG. 9B is a perspective view representing the fuel cell section in the process of being opened.

FIG. 9C is a perspective view indicating the fuel cell section in the open state.

### DETAILED DESCRIPTION OF THE INVENTION

(Best Mode for Carrying Out the Invention)

The following describes an embodiment of the present invention with reference to drawings wherever required:

<<Configuration of Cellular Mobile Telephone>>

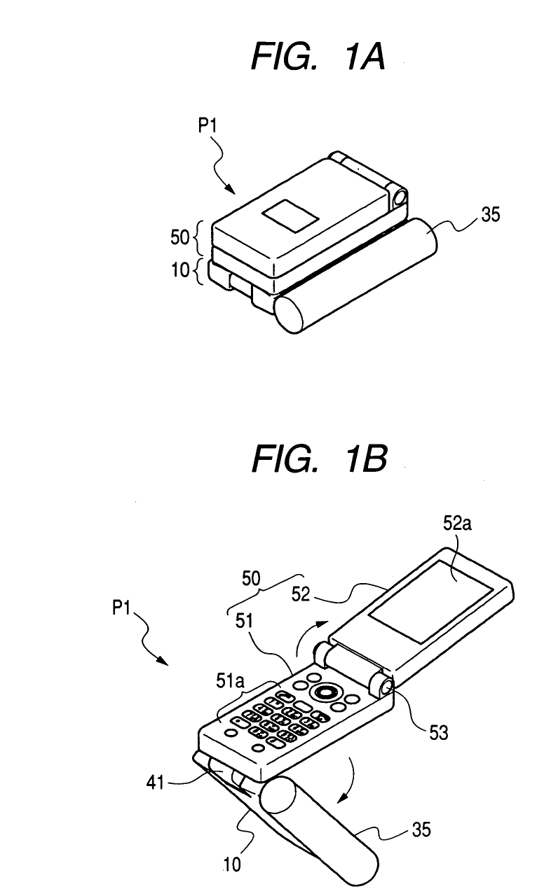

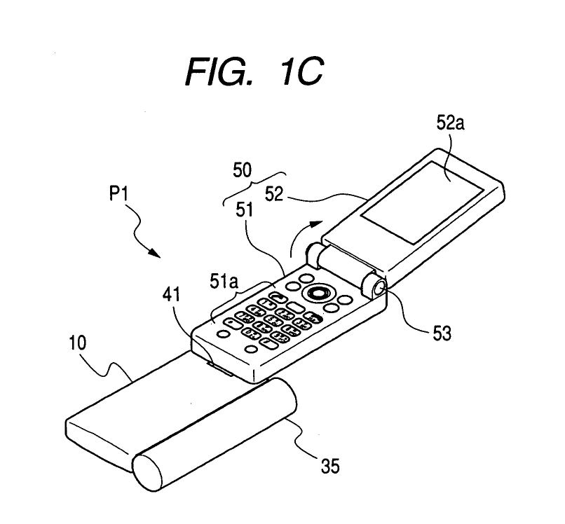

As shown in FIGS. 1A, 1B and 1C, the cellular mobile telephone (electronic components) P1 of the present invention is provided mainly with a cellular mobile telephone body (electronic component body) 50, a fuel cell section 10 for supplying power to the cellular mobile telephone body 50, a fuel cartridge 35 for supplying the fuel cell section 10 with an aqueous solution containing methanol (liquid fuel), and a hinge mechanism (rotating mechanism) 41 for linking the cellular mobile telephone body 50 with the fuel cell section 10 rotatably with respect to each other.

<Cellular Mobile Telephone Body>

The cellular mobile telephone body 50 is a so-called collapsible cellular mobile telephone, and includes an operation section 51 having a dial button 51a and others, and a display section 52 having a liquid crystal panel 52a and others. The operation section 51 and display section 52 are connected with each other by a hinge mechanism 53 so as to form a collapsible structure (see FIGS. 1A, 1B and 1C).

It should be noted, however, that, without being restricted to such a collapsible structure, the cellular mobile telephone body 50 can be designed in a rod-shaped structure (so-called straight shaped structure).

<Fuel Cell Section>

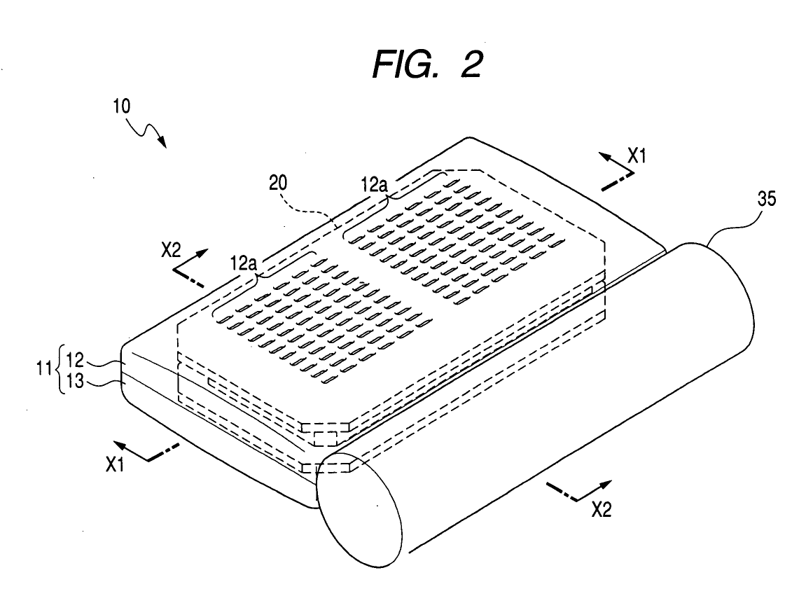

As shown in FIG. 2, the fuel cell section 10 is a plate-formed Direct Methanol Fuel Cell (DMFC), and is provided with a DMFC body 20 and a casing 11 for accommodating the DMFC body 20.

[DMFC Body]

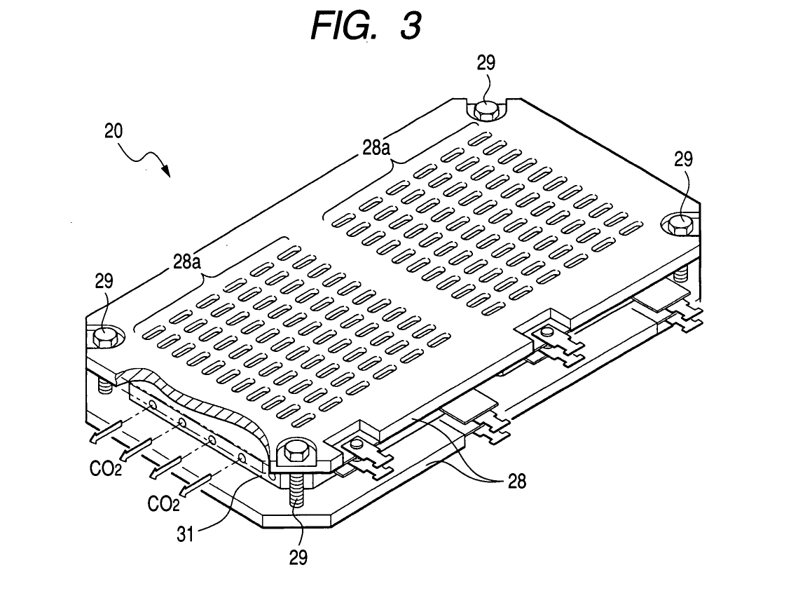

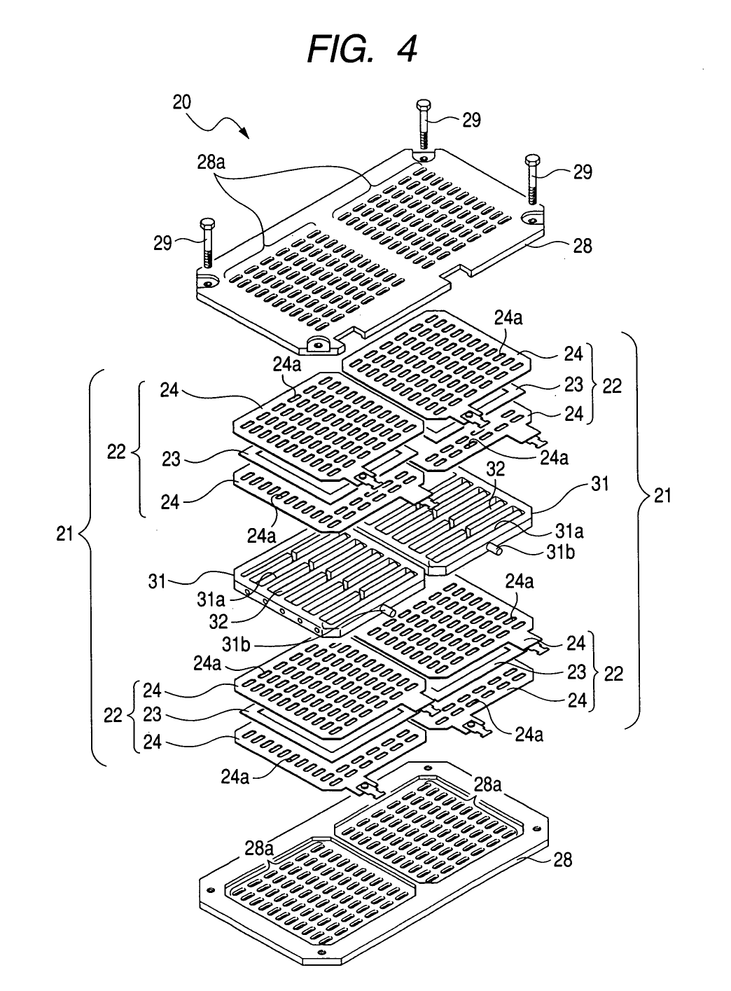

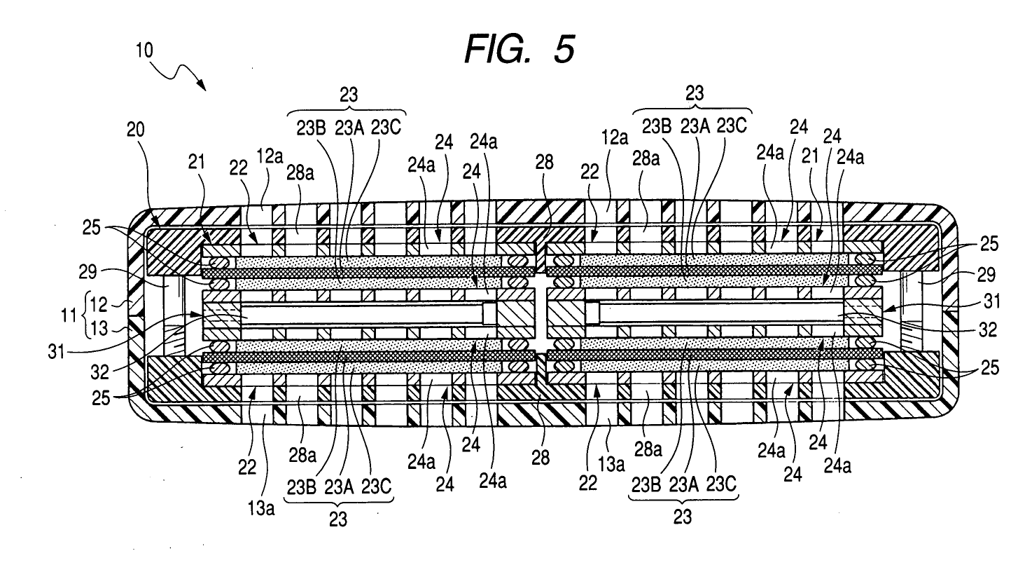

The DMFC body 20 is designed in a plate-formed outer shape (see FIG. 3), and is provided with two cell/fuel tank/cell structures (hereinafter referred to as “cell/tank structures”) 21 and two gripping plates 28, 28 for sandwiching the cell/tank structures 21, as shown in FIG. 4. The two cell/tank structures. 21 are arranged at predetermined positions along the surface, and are sandwiched between the gripping plates 28, 28 (see FIG. 5).

(Cell/Tank Structure)

The cell/tank structure 21 provides with two cells (two single cells) 22 and a fuel tank 31 for leading an aqueous solution containing methanol to each cell 22. Thus, the entire DMFC body 20 is provided with four cells 22 and two fuel tanks 31.

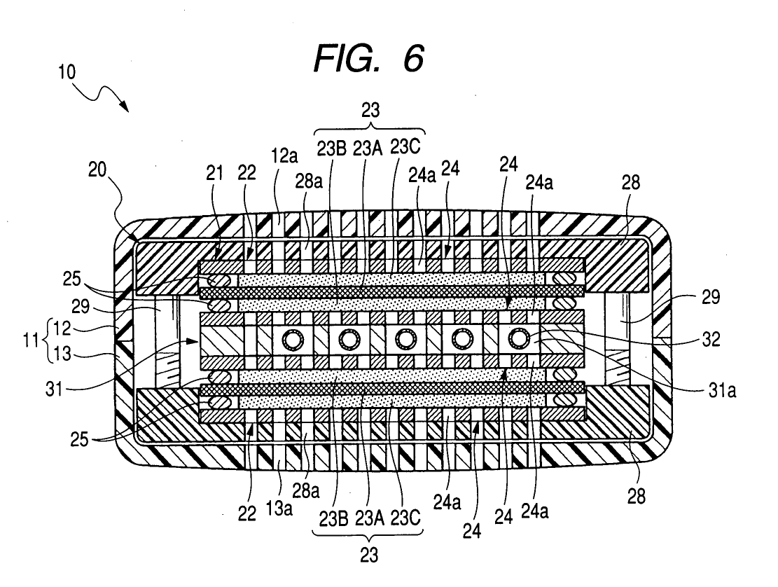

In each cell/tank structure 21, the two cells 22 sandwiches the fuel tank 31 in such a way that the anodes 23B will face each other (see FIGS. 5 and 6). These cells 22 share the fuel tank 31. Accordingly, four cells 22 are arranged on both sides of the fuel cell section 10, namely, on the upper or lower surface thereof.

To cope with power consumption of the cellular mobile telephone body 50, these four cells 22 are connected in series by the connector (not illustrated) such as a jumper, and are then connected to the cellular mobile telephone body 50 through a voltage step-up/step-down circuit (DC-DC converter) (not illustrated) for controlling the output. To store the surplus power and to make up for the power insufficiency, it is also possible to provide a capacitor such as an EDLC (Electric Double Layer Capacitor).

The cell 22 is equipped with an MEA 23, and a pair of current collectors 24, 24 sandwiching the MEA 23. The MEA 23 is provided with an electrolyte membrane 23A, and an anode 23B and cathode 23C sandwiching the electrolyte membrane 23A (FIGS. 5 and 6). Upon supply of an aqueous solution containing methanol to the anode 23B and air including oxygen to the cathode 23C, a potential difference occurs in the MEA 23. If power is consumed by the cellular mobile telephone body 50 in the presence of this potential difference, power is generated by the MEA 23 (cell 22 and fuel cell section 10).

The electrolyte membrane 23A has the function of transporting selectively the proton (H⁺) generated by the anode 23B to the cathode 23C. The electrolyte membrane 23A can be used by adequate selection from among resin membrane based perfluorocarbon sulfonic acid (PFS), trifluorostyrene derivative copolymer membrane, polybenzimidazole membrane impregnated with phosphoric acid, aromatic polyether ketone sulfonic acid membrane, and the membranes made up of PSSA-PVA (polystyrene sulfonic acid polyvinyl alcohol copolymer), PSSA-EVOH (polystyrene sulfonic acid ethylene vinyl alcohol copolymer) and others.

The anode 23B is an electrode also referred to as “gas diffusion electrode”, and forms electrons and protons by oxidizing the methanol as a fuel. The anode 23B is made of conductive member such as carbon paper or carbon cloth. In the aforementioned anode 23B that can be used, the particles of platinum (Pt) and iron (Fe), an alloy formed by transition metal such as nickel (Ni), cobalt (Co) or ruthenium (Ru) and platinum, or particles of oxides as a catalyst are carried on the surface of the anode 23B and facing the electrolyte membrane 23A.

The cathode 23C is an electrode also referred to as “gas diffusion electrode”. The electron passing through the external circuit (cellular mobile telephone body 50) from the anode 23B reacts with the proton having reached the cathode 23C by migrating through the electrolyte membrane 23A subsequent to generation by the anode 23B to form water. The cathode 23C, for example, is made of carbon paper. In the aforementioned anode 23B, a catalyst as platinum is carried on the surface of the cathode 23C and facing the electrolyte membrane 23A, similarly to the case of the anode 23B.

The current collectors 24, 24 are the plates for extracting effectively the electrical energy, based on the potential difference generated by the MEA 23. They are made of the conductive and corrosion-proof material (e.g. such a metal as copper and titanium). The current collectors 24, 24 are overlaid on the anode 23B or cathode 23C. The passage holes 24a for passage of aqueous solution containing methanol or air containing oxygen are formed at adequate positions in the current collectors 24.

As shown in FIGS. 5 and 6, the at adequate positions sealing member (O-ring) 25 are arranged along the surface so as to surround the anode 23B or cathode 23C, and are sandwiched between the electrolyte membrane 23A and the current collectors 24. This arrangement of the sealing member 25 provides sealing to ensure that the aqueous solution containing methanol does not leak from the outer edge of the anode 23B or cathode 23C.

The fuel tank 31 is a secondary tank for temporarily storing the aqueous solution containing methanol fed through the fuel pipe 31b (shown FIG. 4) from the fuel cartridge (primary tank) 35. It also has a function of supplying the aqueous solution containing methanol to all the surfaces of the anodes 23B of the cells 22 located on both sides of the fuel tank 31. To put it more specifically, a slit-like fuel flow path 31a is formed on the fuel tank 31. Incidentally, the fuel flow path 31a is designed to ensure that the aqueous solution containing methanol is supplied to all the surfaces of each of the anodes 23B.

The fuel flow path 31a is provided with an emission tube 32 wherein a gas separation membrane for allowing passage of carbon dioxide on an selective basis is formed in a tubular shape. Because of this arrangement, the carbon dioxide generated by the anode 23B by power generation is mixed with the aqueous solution containing methanol in the fuel flow path 31a, and is then fed into the emission tube 32. This gas emission tube is formed, for example, of the porous membrane based on the polytetrafluoro ethylene.

The hollow portion of the gas emission tube 32 communicates with the outside through the peripheral wall of the fuel tank 31. After passing through the emission tube 32, the carbon dioxide is discharged to the outside (see FIGS. 3 and 5).

(Gripping Plate)

Each of the gripping plates 28, 28 has double the size of the cell/tank structure 21 in the plan view. While sandwiching the two cell/tank structures 21, 21 from both sides, the gripping plates 28, 28 are tightened by bolts 29. Each of the gripping plates 28, 28 is provided with passage holes 28a for passage of air, wherein these holes are located at the positions corresponding to the passage holes 24a formed on the current collectors 24 on the side of the cathode 23C.

[Casing]

The casing 11 is an outer casing to protect the DMFC body 20. This casing 11 is provided with an upper half portion 12 arranged on the upper side of the DMFC body 20, and a lower half portion 13 located on the lower side. Passage holes 12a for passage of air are formed on the upper half portion 12 in a manner corresponding to the passage holes 24a and passage holes 28a. Similarly, passage holes 13a are formed on the lower half portion 13.

<Fuel Cartridge>

The fuel cartridge (see FIG. 1C) 35 is attached on the fuel cell section 10 for supplying an aqueous solution containing methanol to he fuel tank 31, and is filled with aqueous solution containing methanol and propellant gas. This propellant gas pushes the aqueous solution containing methanol out of the fuel cartridge 35 by a piston (not illustrated). The aqueous solution containing methanol having been pushed out is supplied to the fuel tank 31 through a pipe (not illustrated). Further, the fuel cartridge 35 is formed of a transparent material. It is possible to see the remaining amount of the aqueous solution containing methanol in the fuel cartridge 35. The pipe which connects the fuel cartridge 35 to fuel tank 31 is provided with a pressure reducing valve (regulator).

<Hinge Mechanism>

The hinge mechanism 41 (see FIG. 1B) is a rotating mechanism to link the cellular mobile telephone body 50 and the fuel cell section 10 rotatably with respect to each other. The hinge mechanism 41 is composed of a rotary shaft, pin, and pedestal for rotatably supporting the pin as appropriate. By equipping the hinge mechanism 41, the user can opens or closes the fuel cell section 10 with respect to the cellular mobile telephone body 50, as in the case of opening or closing the fuel cell section 10 with respect to the cellular mobile telephone body 50 by the hinge mechanism 53.

<<Effect of Cellular Mobile Telephone>>

The aforementioned cellular mobile telephone P1 provides the following advantages:

When the cellular mobile telephone P1 is not used (when there is no telephone call or mailing), the cellular mobile telephone body 50 is folded, as shown in FIG. 1A. Further, the fuel cell section 10 can also be folded. This arrangement ensures compact configuration of the cellular mobile telephone P1, hence improved portability.

When the cellular mobile telephone P1 is folded, the fuel cell section 10 will not generate power by equipping a cut-off switch for cutting off the electrical connection between the cellular mobile telephone body 50 and fuel cell section 10, and a cut-off valve for cutting off a methanol supply path connecting the fuel cell section 10 with fuel cartridge 35.

Further, when the fuel cell section 10 is folded, the cathodes 23C, 23C on one side are supplied with air. Accordingly, it is also possible to make such a fuel cell section that power is generated by one of the two cells 22, 22 so that the generated power is used to charge the EDLC in preparation for the subsequent startup.

By contrast, when the cellular mobile telephone P1 is used (for telephone call or mailing), the fuel cell section 10 is opened with respect to the cellular mobile telephone body 50, as shown in FIGS. 1B and 1C. This procedure allows the cathode 23C of each cell 22 to be released to the outside, whereby all the four cells 22 generate power with high efficiency, with the result that a high power output is produced by the fuel cell section 10.

The above has described an example of the preferred embodiment of the present invention. It is to be expressly understood, however, that the present invention is not restricted thereto. The present invention can be embodied in a great number of variations with appropriate modification or additions, without departing from the technological spirit and scope of the invention claimed. An example of such modification will be shown below.

In the aforementioned embodiment, the fuel cell section 10 and cellular mobile telephone body 50 are designed to be rotatable with respect to each other by the hinge mechanism 41 (rotating mechanism) so they can be folded, as shown in FIG. 1B. However, the mode of rotation is not restricted thereto. That is, the rotating mechanism can be designed in any structure, just as long as the cellular mobile telephone body 50 and fuel cell section 10 rotate with respect to each other, and air is supplied to the cathodes 23C, 23C of the cells 22, 22 located on both sides of the fuel cell section 10 by relative rotation.

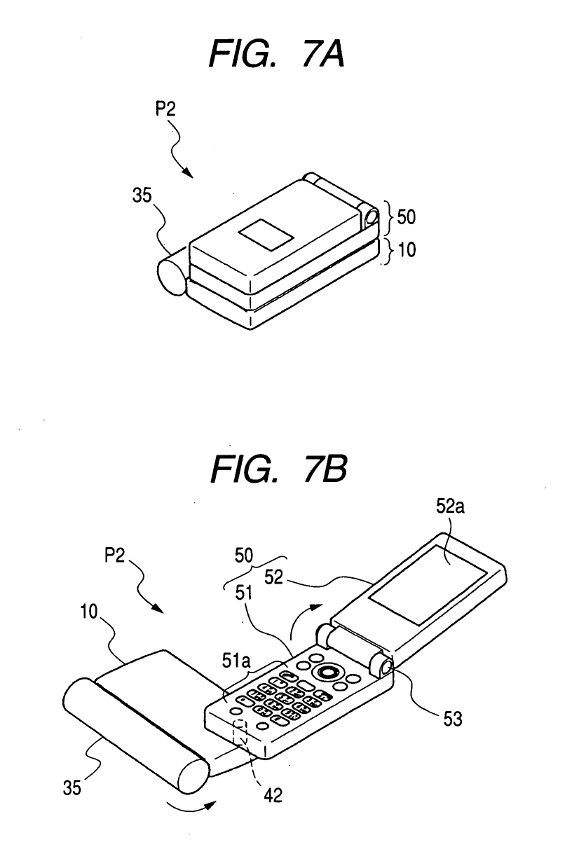

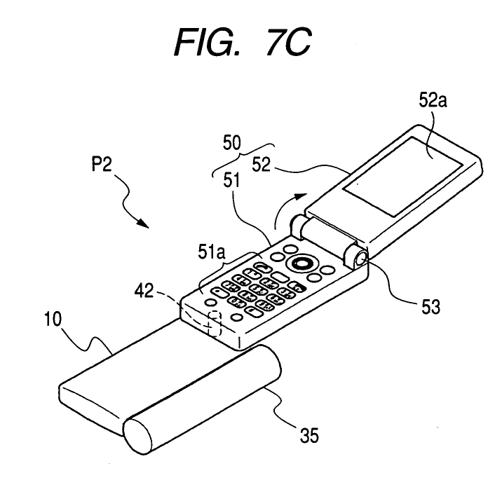

For example, as shown in FIGS. 7A, 7b and 7C, the cellular mobile telephone P2 is equipped with a rotating mechanism 42 having a rotary shaft perpendicular to the surfaces of the fuel cell section 10 and operation section 51. The rotating mechanism 42 provides relative rotation of the fuel cell section 10 and cellular mobile telephone body 50 on approximately the same plane.

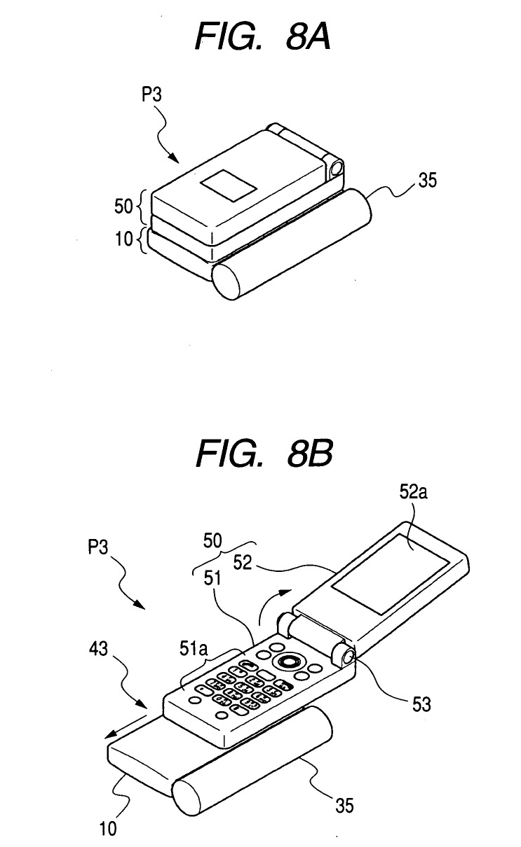

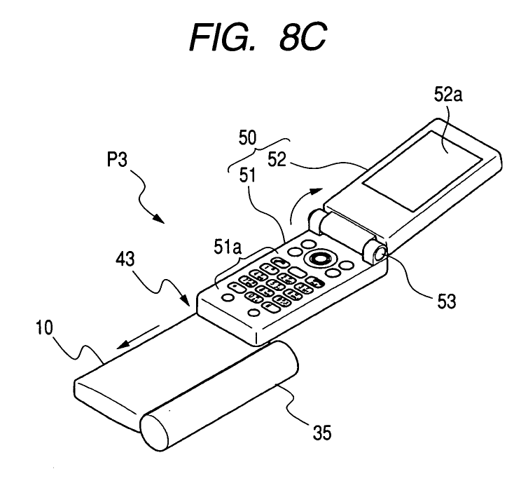

In the aforementioned embodiment, the cellular mobile telephone P1 has a hinge mechanism 41. It is also possible to use the structure of the cellular mobile telephone P3 shown in FIGS. 8A, 8B and 8C. The cellular mobile telephone P3 is equipped with a fuel cell section 10, a cellular mobile telephone body 50 and a sliding mechanism 43. Incidentally, this sliding mechanism 43 connects the cellular mobile telephone body 50 with the fuel cell section 10 slidably. In the cellular mobile telephone P3, air is supplied to the cathodes 23C of the cells 22 located on both sides of the fuel cell section 10 when the fuel cell section 10 is made to slide with respect to the cellular mobile telephone body 50, whereby the fuel cell section 10 generates high power output. The sliding mechanism 43 is made up of a guide rail and a guide sliding along the guide rail, as appropriate.

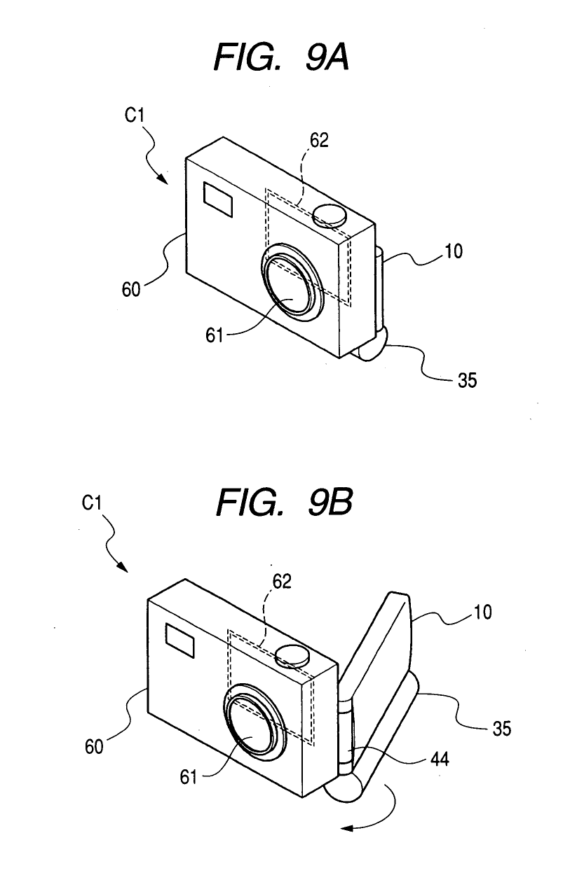

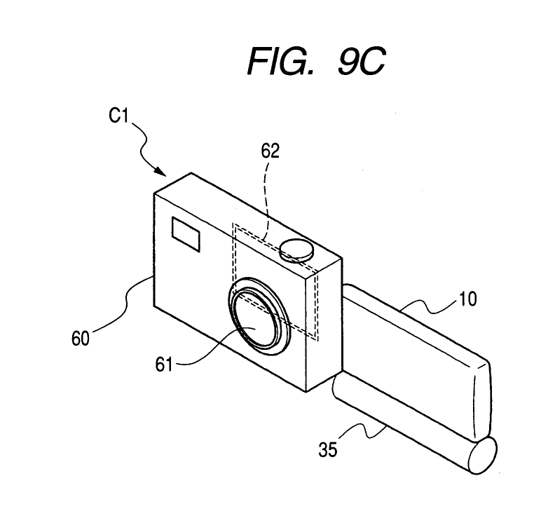

The aforementioned embodiment refers to the case where the electronic components is a cellular mobile telephone P1, without the type of the electronic components being restricted thereto. For example, it can be a digital camera C1, as shown in FIGS. 9A, 9B and 9C. The digital camera C1 is provided with a camera body 60, a fuel cell section 10, a hinge mechanism 44 for linking the camera body 60 with the fuel cell section 10 rotatably with respect to each other. The camera body 60 has a lens 61 on the front and a liquid crystal finder 62 on the rear.

At the time of photographing, the fuel cell section 10 is rotated with respect to the camera body 60, whereby air is supplied to the cathodes 23 of the cells 22 (se FIGS. 5 and 6). At the same time, a photograph can be taken by observing the liquid crystal finder 62. In the meantime, when a photograph is not taken (i.e. when the digital camera C1 is not used), the fuel cell section 10 is folded, the size of the digital camera C1 becomes small, and the portability is improved. In the folded state, the fuel cell section 10 covers and protects the liquid crystal finder 62.

What is claimed is:

1. Electronic components comprising:
a plate-formed fuel cell section having at least two cells for generating power by a liquid fuel being supplied to the anode and an oxidizing gas to the cathode, wherein said two or more cells are arranged on both sides thereof;
an electronic component body utilizing the power of said fuel cell section; and
a rotating mechanism for linking said fuel cell section and electronic component rotatably with respect to each other.

2. Electronic components comprising:
a plate-formed fuel cell section having at least two cells for generating power by a liquid fuel being supplied to the anode and an oxidizing gas to the cathode, wherein said two or more cells are arranged on both sides thereof;
an electronic component body utilizing the power of said fuel cell section; and
a sliding mechanism for linking said fuel cell section and electronic component slidably with respect to each other.
